(19) United States
(12) Patent Application Publication
(10) Pub. No.: US 2011/0254784 A1
(43) Pub. Date: Oct. 20, 2011

(54) CONTROLLING METHOD AND INFORMATION PROCESSING APPARATUS

(75) Inventor: Yusuke YAMADA, Shiojiri-shi (JP)

(73) Assignee: SEIKO EPSON CORPORATION, Tokyo (JP)

(21) Appl. No.: 13/081,333

(22) Filed: Apr. 6, 2011

(30) Foreign Application Priority Data
Apr. 14, 2010 (JP) 2010-093102

(51) Int. Cl. G06F 3/041

(52) U.S. Cl. 345/173

(57) ABSTRACT

A controlling method performed by an information processing apparatus including an input device and a CPU, includes: acquiring input data including input position information indicating an input position at which an input is made in the input device; determining whether or not the input position indicated by the input position information included in the input data corresponds to a predetermined enterable area; and switching, when the CPU is in a first operating state and it is determined that the input position corresponds to the enterable area, the CPU from the first operating state to a second operating state where the power consumption is greater than that in the first operating state.

### BACKGROUND

1. Technical Field

The present invention relates to a controlling method and an information processing apparatus.

2. Related Art

JP-A-2009-223631 discloses an electronic writing tool that allows handwriting input in which a processing mode (writing mode or reference mode) is detected based on the state of a switch, and an internal operation (irradiation condition, output condition, or decoding condition) is varied depending on the detected processing mode for reducing the power consumption.

On the other hand, in an information processing apparatus in the related art, a technique of setting a CPU (Central Processing Unit) to a so-called power-saving mode until some kind of processing is requested is used for suppressing the amount of power consumption. In the related art, however, the information processing apparatus responds even to an unwanted input to the information processing apparatus, such as the case where, for example, a user erroneously touches an input screen, and therefore the CPU returns from the power-saving mode. Because of such a fact, suppressing the amount of power consumption of the information processing apparatus is not easy in the related art.

### SUMMARY

An advantage of some aspects of the invention is to provide a mechanism for suppressing the amount of power consumption of an information processing apparatus.

A first aspect of the invention is directed to a controlling method performed by an information processing apparatus including an input device and a CPU, including: an acquiring step of acquiring input data including input position information indicating an input position at which an input is made in the input device; a determining step of determining whether or not the input position indicated by the input position information included in the input data corresponds to a predetermined enterable area; and a state switching step of switching, when the CPU is in a first operating state and it is determined in the determining step that the input position corresponds to the enterable area, the CPU from the first operating state to a second operating state where the power consumption is greater than that in the first operating state. According to the controlling method according to the first aspect of the invention, even when an unwanted input is made to the information processing apparatus, such as the case where a user touches an area other than a predetermined enterable area, the CPU does not return from the first operating state. Therefore, the amount of power consumption of the information processing apparatus can be suppressed.

The controlling method may be configured such that the controlling method further includes a storing step of causing a storage section to store information indicating an area where an input can be made in the input device as information indicating the enterable area when the CPU transitions from the second operating state to the first operating state, and in the determining step, it is determined with reference to the information indicating the enterable area stored in the storage section whether or not the input position specified by the input data corresponds to the enterable area. According to the configuration, it is sufficient to read a criterion for determining whether or not the input position corresponds to the enterable area from the storage section, which eliminates the need to make an inquiry to the CPU or the like. Therefore, the amount of power consumption of the information processing apparatus can be suppressed. Moreover, every time the CPU transitions to the first operating state, the newest determination criterion of an enterable area requested by the CPU at the time can be stored in the storage section.

The controlling method may be configured such that the controlling method further includes a first transferring step of transferring the input data to the CPU when the CPU is in the second operating state. According to the configuration, without hindering the execution of processing on the input data by the CPU when the CPU is in the second operating state, the amount of power consumption of the information processing apparatus can be suppressed.

The controlling method may be configured such that the controlling method further includes a second transferring step of transferring the input data to the CPU when the CPU is in the first operating state and it is determined in the determining step that the input position corresponds to the enterable area. According to the configuration, the CPU can use the transferred input data to perform processing according to an input through the input device. Accordingly, without hindering the execution of processing on the input data by the CPU after the CPU returns to the second operating state, the amount of power consumption of the information processing apparatus can be suppressed.

The controlling method may be configured such that when the CPU receives the input data in the first operating state, the CPU can be switched from the first operating state to the second operating state, and the input data is transferred to the CPU in the second transferring step, whereby the CPU is switched from the first operating state to the second operating state. According to the configuration, there is no need to perform processing for sending information for switching the CPU from the first operating state to the second operating state to the CPU, separately from processing for transferring input data. Accordingly, it is possible with a simpler configuration to control the switching of the state of the CPU and suppress the amount of power consumption of the information processing apparatus.

A second aspect of the invention is directed to an information processing apparatus including: an input device; a CPU; an acquiring section that acquires input data including input position information indicating an input position at which an input is made in the input device; a determining section that determines whether or not the input position indicated by the input position information included in the input data corresponds to a predetermined enterable area; and a state switching section that switches, when the CPU is in a first operating state and it is determined by the determining section that the input position corresponds to the enterable area, the CPU from the first operating state to a second operating state where the power consumption is greater than that in the first operating state. According to the information processing apparatus according to the second aspect of the invention, even when an unwanted input is made to the information processing apparatus, such as the case where a user touches an area other than a predetermined enterable area, the CPU does not return from the first operating state. Therefore, the amount of power consumption of the information processing apparatus can be suppressed.

### BRIEF DESCRIPTION OF THE DRAWINGS

The invention will be described with reference to the accompanying drawings, wherein like numbers reference like elements.

FIG. 1 shows an appearance of a terminal apparatus.

FIG. 2 shows a hardware configuration of the terminal apparatus.

FIG. 3 shows a functional configuration of a control circuit.

FIG. 4 shows procedures of processing performed by the terminal apparatus when a CPU is in a sleep mode.

FIG. 5 shows procedures of processing performed by the terminal apparatus when the CPU is in a non-sleep mode.

FIG. 6 shows an example of enterable areas.

FIG. 7 shows a modified example of enterable areas.

### DESCRIPTION OF EXEMPLARY EMBODIMENTS

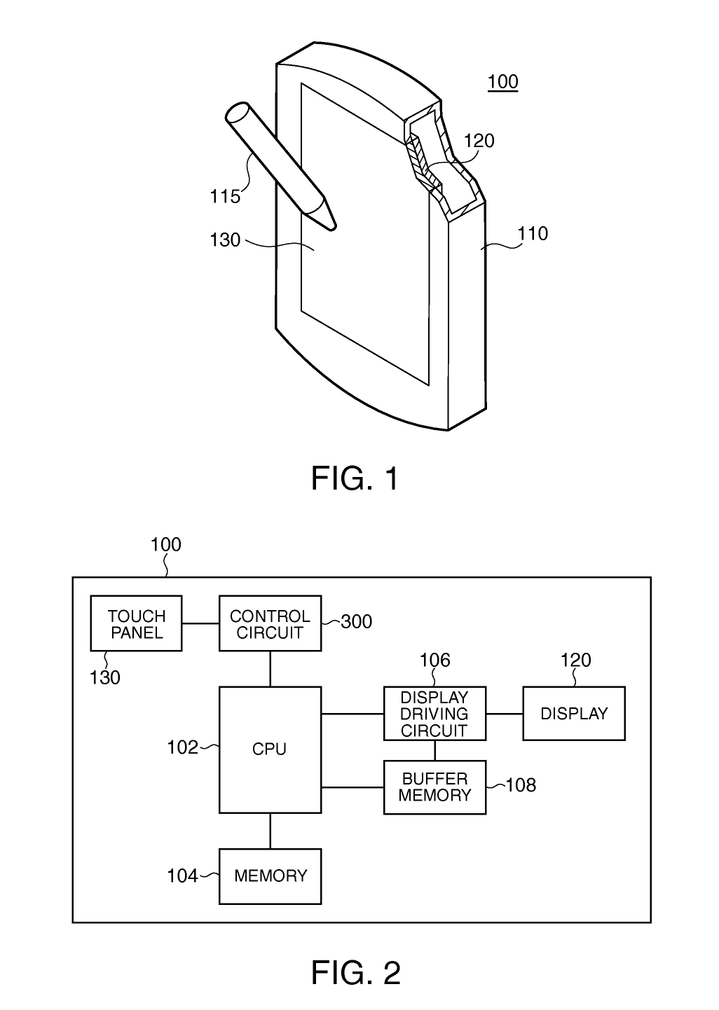

FIG. 1 shows an appearance of a terminal apparatus 100 according to an embodiment. The terminal apparatus 100 is an information processing apparatus that allows the display and input of various kinds of information. The terminal apparatus 100 is an example of an information processing apparatus according to the invention. Examples of the terminal apparatus 100 include, for example, electronic books, PDAs (Personal Digital Assistants), mobile phones, portable music players, portable video players, and portable navigation systems.

The terminal apparatus 100 includes a housing 110, a display 120, and a touch panel 130. The housing 110 contains various kinds of hardware of the terminal apparatus 100, such as a power supply, a CPU, a memory, a hard disk, the display 120, the touch panel 130, a display driving circuit, a power supply control circuit, and a communication interface.

The display 120 is an example of a display device according to the invention. The display 120 is provided inside the housing 110 so as to expose a display surface of the display through an opening formed in the front surface (surface facing a user when the user observes a display screen of the display 120 in a plan view manner) of the housing 110. The display 120 displays various kinds of information. For example, the display 120 can display characters, graphics, images, management information, buttons, icons, etc. The display 120 can also display characters or graphics entered by handwriting to the touch panel 130. The terminal apparatus 100 of the embodiment uses, as the display 120, a display device utilizing an electrophoresis method. The display 120 is not limited to the display device utilizing an electrophoresis method, but may be another type display device such as liquid crystal displays, plasma displays, or organic EL displays.

The touch panel 130 is an example of an input device according to the invention. The touch panel 130 is overlaid on the display surface of the display 120. The terminal apparatus 100 accepts an information input by a stylus pen 115 or the like through the touch panel 130. To the terminal apparatus 100, character data representing a handwritten character or graphic data representing a handwritten graphic can be entered through the touch panel 130. The terminal apparatus 100 may accept an information input by the stylus pen 115 or the like through, instead of the touch panel 130, an electromagnetic induction type sensor board or the like provided below the display surface of the display 120.

FIG. 2 shows a hardware configuration of the terminal apparatus 100. As shown in FIG. 2, the terminal apparatus 100 includes, in addition to the display 120 and the touch panel 130 described with reference to FIG. 1, a CPU 102, a memory 104, a display driving circuit 106, a buffer memory 108, and a control circuit 300. Other than these, the terminal apparatus 100 has a power supply, a hard disk, a power supply control circuit, a communication interface, etc. However, since these are not necessary for describing the embodiment, their illustrations and descriptions are omitted.

The CPU 102 performs various kinds of processing. The memory 104 stores various kinds of data and various kinds of programs used by the CPU 102. The CPU 102 reads a program and data necessary for processing from the memory 104 and uses the data read from the memory 104 to execute the program read from the memory 104, thereby performing predetermined processing.

When the processing performed by the CPU 102 involves displaying a processing result, the CPU 102 sends display data indicating the processing result to the display driving circuit 106. The display driving circuit 106 causes the display 120 to display an image corresponding to the received display data. Specifically, the CPU 102 causes the buffer memory 108 such as an SDRAM (Synchronous Dynamic Random Access Memory) to store the display data. The display driving circuit 106 reads the display data stored in the buffer memory 108. The display driving circuit 106 drives the display 120 to cause the display 120 to display an image corresponding to the read display data.

For example, when handwritten character data or handwritten graphic data is entered through the touch panel 130, the CPU 102 receives the data entered through the touch panel 130 (hereinafter referred to as “input data”) from the touch panel 130. Specifically, the input data includes input position information indicating an input position (coordinates) on an input detection surface of the touch panel 130. When a handwritten character or a handwritten graphic is entered, the input data includes input position information indicating a plurality of input positions that are continuous in time series on the stroke of the character or graphic. The CPU 102 generates, from the received input data, display data for displaying an image corresponding to the input data. Further, the CPU 102 sends the generated display data to the display driving circuit 106. The display driving circuit 106 drives the display 120 to cause the display 120 to display the image corresponding to the read display data. In this manner, the image corresponding to handwritten character data or handwritten graphic data entered through the touch panel 130 is displayed on the display 120.

Here, as modes (operating states) of the CPU 102, there are a sleep mode (first operating state) and a non-sleep mode (second operating state). In the sleep mode, the CPU 102 suspends a part or all of operations. In the non-sleep mode, on the other hand, the CPU 102 does not suspend operations. The power consumption of the CPU 102 per unit time in the non-sleep mode is greater than the power consumption of the CPU 102 per unit time in the sleep mode. In the non-sleep mode, when there is no any input for a certain period of time for example, the mode of the CPU 102 transitions from the non-sleep mode to the sleep mode. On the other hand, the CPU 102 transitions from the sleep mode to the non-sleep mode as follows.

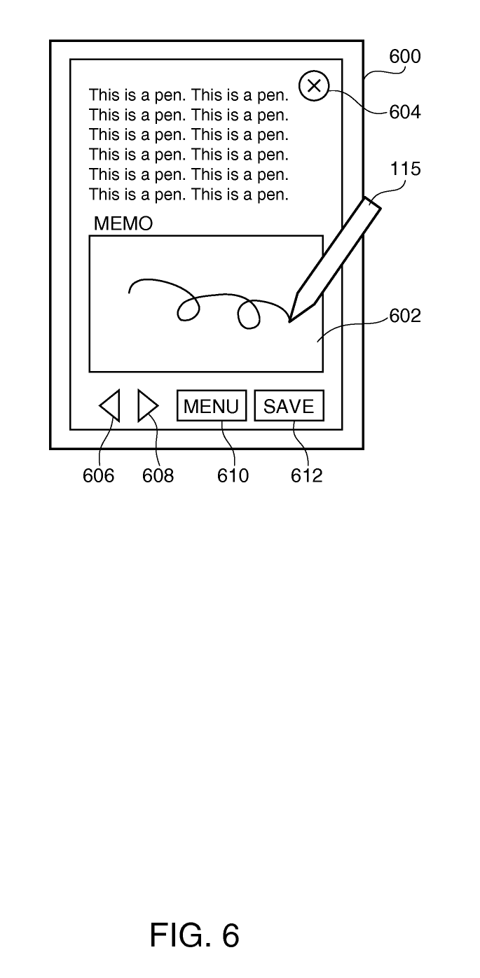

The control circuit 300, which is a control circuit different from a main circuit in which the CPU 102 is provided, controls the switching of the mode of the CPU 102 according to the mode of the CPU 102 and an input position specified by input data. For example, when the CPU 102 is in the sleep mode and data is entered through the touch panel 130, the control circuit 300 switches the mode of the CPU 102 from the sleep mode to the non-sleep mode. In this case, when data is entered into a predetermined enterable area in the touch panel 130, the control circuit 300 performs the switching described above. While data is entered into an area other than the enterable area, the control circuit 300 does not perform the switching. The “enterable area” used herein means an area where an input from a user is accepted, such as soft buttons or a handwriting input field displayed on the display 120 that is overlaid on the touch panel 130, as shown in FIG. 6 described later. On the other hand, when the CPU 102 is in the non-sleep mode and data is entered through the touch panel 130, the control circuit 300 does not perform the switching of the mode of the CPU 102. That is, the CPU 102 performs processing according to the data entered through the touch panel 130 while staying in the non-sleep mode.

Moreover, the control circuit 300 controls an input through the touch panel 130 according to the mode of the CPU 102 and an input position specified by input data. For example, when the CPU 102 is in the sleep mode and data is entered into the enterable area, the control circuit 300 outputs the input data to the CPU 102. Similarly, when the CPU 102 is in the non-sleep mode and data is entered into the enterable area, the control circuit 300 outputs the input data to the CPU 102. On the other hand, when the CPU 102 is in the sleep mode and data is entered into the area other than the enterable area, the control circuit 300 does not output the input data to the CPU 102. That is, the data entered through the touch panel 130 is substantially nullified.

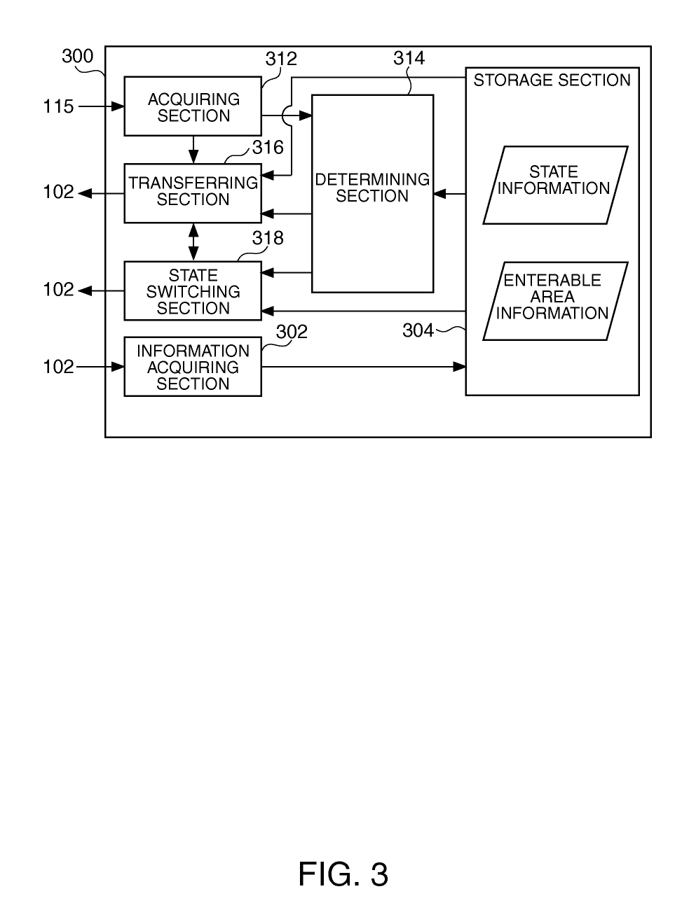

FIG. 3 shows a functional configuration of the control circuit 300. The control circuit 300 includes an information acquiring section 302 and a storage section 304. The information acquiring section 302 acquires state information for identifying the mode of the CPU 102, that is, state information indicating whether the CPU is in the sleep mode or in the non-sleep mode. Moreover, the information acquiring section 302 acquires enterable area information indicating the position of the enterable area in the touch panel 130. For example, the information acquiring section 302 acquires these pieces of information from the CPU 102 when the CPU 102 transitions from the non-sleep mode to the sleep mode. The information acquiring section 302 causes the storage section 304 to store these acquired pieces of information. When these pieces of information have already been stored in the storage section 304, the information acquiring section 302 updates the information stored in the storage section 304 with the acquired information.

The control circuit 300 further includes an acquiring section 312, a determining section 314, a transferring section 316, and a state switching section 318. The acquiring section 312 acquires input data including input position information indicating an input position at which an input is made in the touch panel 130. From the touch panel 130 in this case, input data including an input position represented by the same coordinate system as that of the enterable area information stored in the storage section 304 may be supplied, or input data including an input position represented by a coordinate system different from that of the enterable area information may be supplied.

The determining section 314 determines whether or not the input position specified by the input data acquired by the acquiring section 312 corresponds to a predetermined enterable area. Specifically, with reference to the enterable area information stored in the storage section 304, the determining section 314 determines whether or not the input position corresponds to the predetermined enterable area. When the acquiring section 312 acquires input data including input position represented by a coordinate system different from that of the enterable area information, the determining section 314 may use a predetermined mathematical formula or correspondence table to convert the coordinate system of the input position information included in the input data into the input position represented by the coordinate system of the enterable area information, and then may determine whether or not the input position corresponds to the predetermined enterable area.

The transferring section 316 transfers the input data acquired by the acquiring section 312 to the CPU 102. When the CPU 102 is in the non-sleep mode in this case, the transferring section 316 transfers the input data to the CPU 102 irrespective of the input position specified by the input data. On the other hand, when the CPU 102 is in the sleep mode, the transferring section 316 transfers or does not transfer the input data to the CPU 102 according to the input position. Specifically, when the CPU 102 is in the sleep mode and the determining section 314 determines that the input position corresponds to a predetermined enterable area, the transferring section 316 transfers the input data to the CPU 102. On the other hand, when the CPU 102 is in the sleep mode and the determining section 314 determines that the input position does not correspond to the predetermined enterable area, the transferring section 316 does not transfer the input data to the CPU 102.

The state switching section 318 switches the mode of the CPU 102. Specifically, when the CPU 102 is in the sleep mode and the determining section 314 determines that the input position corresponds to the predetermined enterable area, the state switching section 318 switches the CPU 102 from the sleep mode to the non-sleep mode. On the other hand, when the determining section 314 determines that the input position does not correspond to the predetermined enterable area, the transferring section 316 does not perform the switching of the CPU 102. When the state switching section 318 switches the CPU 102 from the sleep mode to the non-sleep mode in this case, the state switching section 318 may send information (for example, a command to instruct the CPU 102 to switch from the sleep mode to the non-sleep mode) for switching the CPU 102 from the sleep mode to the non-sleep mode to the CPU 102, thereby switching the CPU 102 from the sleep mode to the non-sleep mode.

On the other hand, when the CPU 102 receives the input data in the sleep mode, if the CPU can switch from the sleep mode to the non-sleep mode, the transferring section 316 transfers the input data to the CPU 102, whereby the control circuit 300 may switch the CPU 102 from the sleep mode to the non-sleep mode.

For example, the functions of the information acquiring section 302, the acquiring section 312, the transferring section 316, and the state switching section 318 are realized by executing predetermined programs with a CPU included in the control circuit 300 together with the utilization of a communication interface such as a serial port. The function of the storage section 304 is realized with a memory included in the control circuit 300. The function of the determining section 314 is realized by executing a predetermined program with the CPU included in the control circuit 300. A CPU whose amount of power consumption is less than that of the CPU 102 is preferably used for the CPU included in the control circuit 300. Moreover, a CPU whose amount of power consumption is less than that of the CPU 102 in the non-sleep mode is preferably used for the control circuit 300. The functions realized by executing predetermined programs with the CPU in the control circuit 300 may be realized by mechanical processing in the terminal apparatus 100.

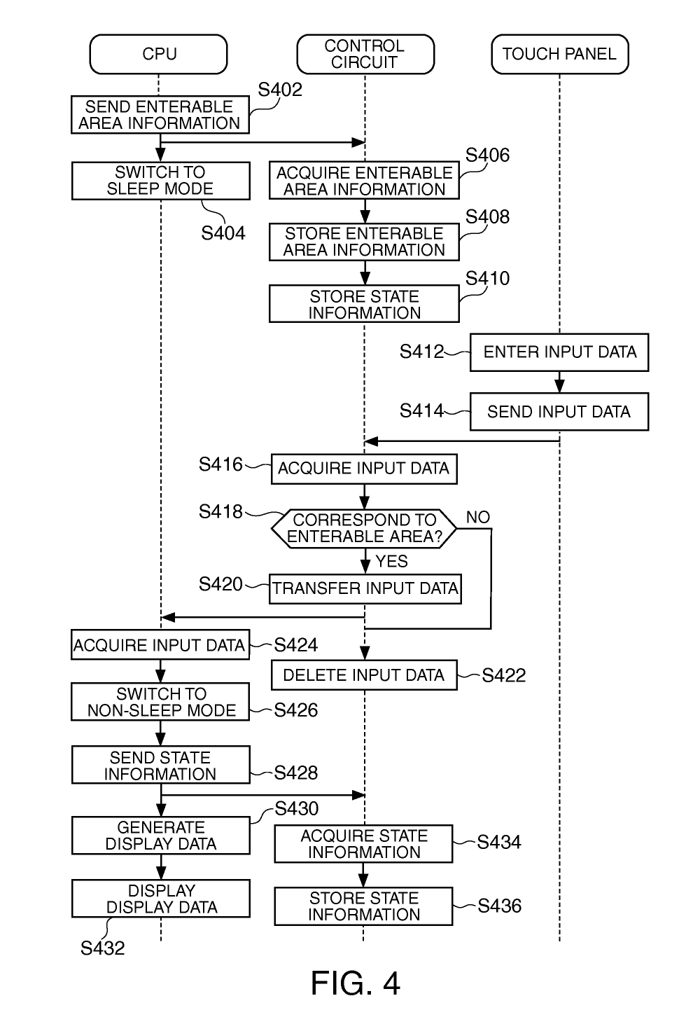

FIG. 4 shows procedures of processing performed by the terminal apparatus 100 when the CPU 102 is in the sleep mode. Here, the processing procedures of the terminal apparatus 100 when the CPU 102 is in the sleep mode will be described. As described above, when there is no input in the non-sleep mode for a certain period of time for example, the mode of the CPU 102 transitions from the non-sleep mode to the sleep mode. In this case, the CPU 102 first specifies an enterable area with reference to the contents of an image displayed on the display 120 at the time and supplies enterable area information indicating the position of the enterable area in the touch panel 130 to the control circuit 300 (Step S402). Then, the CPU 102 switches from the non-sleep mode to the sleep mode (Step S404). In the control circuit 300, the information acquiring section 302 acquires the enterable area information supplied at Step 5402 (Step S406) and causes the storage section 304 to store the enterable area information acquired at Step S406 (Step S408). Here, the information acquiring section 302 determines based on the fact of the acquisition of the enterable area information that the CPU 102 switches from the non-sleep mode to the sleep mode, and causes the storage section 304 to store state information indicating the CPU 102 being in the sleep mode (Step S410).

Subsequently, when input data is entered to the touch panel 130 (Step S412), the touch panel 130 supplies the input data entered at Step S412 to the control circuit 300 (Step S414).

In the control circuit 300, the acquiring section 312 acquires the input data supplied at Step S414 (Step S416). Then, the determining section 314 specifies an input position in the touch panel 130 based on input position information included in the input data acquired at Step S416, and further determines whether or not the input position corresponds to the enterable area indicated by the enterable area information stored in the storage section 304 at Step S408 (Step S418). In this case, the determining section 314 converts a coordinate system of the input position information included in the input data as needed.

When it is determined at Step S418 that the input position specified by the input data acquired at Step S416 corresponds to the predetermined enterable area (Yes at Step S418), the transferring section 316 transfers the input data acquired at Step S416 to the CPU 102 (Step S420). On the other hand, when it is determined at Step S418 that the input position specified by the input data acquired at Step S416 does not correspond to the predetermined enterable area (No at Step S418), the control circuit 300 deletes the input data acquired at Step S416 (Step S422).

The CPU 102 is set so as to switch from the sleep mode to the non-sleep mode when input data is transferred. Therefore, when the CPU 102 acquires the input data transferred at Step S420 (Step S424), the CPU switches from the sleep mode to the non-sleep mode based on the fact of the acquisition (Step S426), and supplies state information indicating the effect to the control circuit 300 (Step S428). Then, the CPU 102 generates display data according to the input data acquired at Step S424 (Step S430), and causes the display 120 to display the display data generated at Step S430 (Step S432). In conjunction with the processing described above, in the control circuit 300, the information acquiring section 302 acquires the state information sent at Step S428 (Step S434), and causes the storage section 304 to store the state information acquired at Step S434 (Step S436). When the input data acquired at Step S424 is for control and does not involve display, the CPU 102 does not perform the generation processing of the display data (Step S430) and the display processing of display data (Step S432), and instead performs control processing according to the input data.

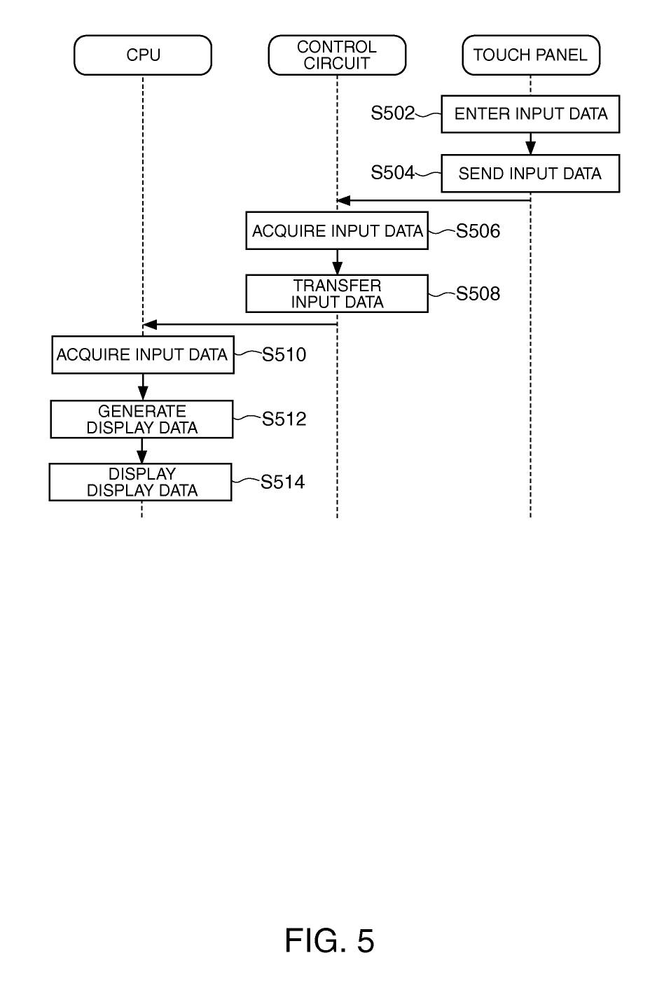

FIG. 5 shows procedures of processing performed by the terminal apparatus 100 when the CPU 102 is in the non-sleep mode. Here, the processing procedures of the terminal apparatus 100 when the CPU 102 is in the non-sleep mode will be described. When input data is entered to the touch panel 130 (Step S502), the touch panel 130 sends the input data entered at Step S502 to the control circuit 300 (Step S504).

In the control circuit 300, the acquiring section 312 acquires the input data sent at Step S504 (Step S506). Then, the transferring section 316 transfers the input data acquired at Step S506 to the CPU 102 (Step S508).

The CPU 102 acquires the input data transferred at Step S508 (Step S510), generates display data according to the input data acquired at Step S510 (Step S512), and causes the display 120 to display the display data generated at Step S512 (Step S514). When the input data acquired at Step S510 is for control and does not involve display, the CPU 102 does not perform the generation processing of display data (Step S512) and the display processing of display data (Step S514), and instead performs control processing according to the input data.

FIG. 6 shows an example of enterable areas. A screen 600 shown in FIG. 6 is a screen displayed on the display 120. On the screen 600, an image 602, an image 604, an image 606, an image 608, an image 610, and an image 612 are displayed. The image 602 is an image showing the handwriting input field. The image 604 is an image of the soft button for closing the screen 600. The image 606 is an image of the soft button for restoring handwriting input processing. The image 608 is an image of the soft button for proceeding with handwriting input processing. The image 610 is an image of the soft button for displaying a menu screen. The image 612 is an image of the soft button for saving a handwriting input.

In the embodiment, an area where the image 602 is displayed, an area where the image 604 is displayed, an area where the image 606 is displayed, an area where the image 608 is displayed, an area where the image 610 is displayed, and an area where the image 612 is displayed are enterable areas. An area excluding the enterable areas, that is, the area where the image 602 is displayed, the area where the image 604 is displayed, the area where the image 606 is displayed, the area where the image 608 is displayed, the area where the image 610 is displayed, and the area where the image 612 is displayed, is the area other than the enterable areas. At Step S418, which has been previously described, the determining section 314 determines to which of the enterable areas, that is, the area where the image 602 is displayed, the area where the image 604 is displayed, the area where the image 606 is displayed, the area where the image 608 is displayed, the area where the image 610 is displayed, and the area where the image 612 is displayed, an input position in the touch panel 130 corresponds.

In the case where the screen 600 described above is displayed on the display 120 and the CPU 102 is in the sleep mode, when input data is entered into any of the enterable areas in the touch panel 130, the CPU 102 is switched to the non-sleep mode by the control of the control circuit 300 and performs processing according to the input data transferred from the control circuit 300. For example, when a handwritten character is entered into the handwriting input field, the CPU 102 generates display data of the handwritten character and causes the display 120 to display the display data in the handwriting input field. When any of the soft buttons is pressed, the CPU 102 performs control processing according to the pressed soft button.

In the case where the screen 600 described above is displayed on the display 120 and the CPU 102 is in the non-sleep mode, even when input data is entered into any of the areas in the touch panel 130, the CPU 102 performs processing according to the input data directly transferred from the control circuit 300.

On the other hand, in the case where the screen 600 described above is displayed on the display 120 and the CPU 102 is in the sleep mode, when input data is entered into the area other than the enterable areas in the touch panel 130, the input data is not transferred to the CPU 102 by the control of the control circuit 300. Accordingly, the CPU 102 maintains the sleep mode and does not perform processing according to the entered input data.

As has been described above, the control circuit 300 of the embodiment is configured such that the control circuit determines whether or not an input position specified by input data entered through the touch panel 130 corresponds to a predetermined enterable area, and when the CPU 102 is in the first operating state and it is determined that the input position corresponds to the predetermined enterable area, the CPU 102 is switched from the first operating state to the second operating state. Thus, even when an unwanted input is made to the terminal apparatus 100, such as the case where a user erroneously touches an area other than the enterable area on the touch panel 130, the CPU 102 does not return from the first operating state. Therefore, the amount of power consumption of the terminal apparatus 100 can be suppressed.

The control circuit 300 of the embodiment is configured such that when the CPU 102 transitions from the second operating state to the first operating state, information indicating an enterable area in the touch panel 130 is stored in the storage section 304. According to the configuration, it is sufficient to read a criterion for determining whether or not an input position corresponds to an enterable area from the storage section 304, which eliminates the need to make an inquiry to the CPU 102 or the like. Therefore, the amount of power consumption of the terminal apparatus 100 can be suppressed. Moreover, every time the CPU 102 transitions to the first operating state, the newest determination criterion of an enterable area requested by the CPU 102 at the time can be stored in the storage section 304.

The control circuit 300 of the embodiment is configured such that when the CPU 102 is in the second operating state, input data is transferred to the CPU 102. Thus, without hindering the execution of processing on the input data by the CPU 102 when the CPU 102 is in the second operating state, the amount of power consumption of the terminal apparatus 100 can be suppressed.

The control circuit 300 of the embodiment is configured such that when the CPU 102 is in the first operating state and it is determined that an input position is within a predetermined enterable area, input data is transferred to the CPU 102. Thus, the CPU 102 can use the transferred input data to perform processing according to the input through the touch panel 130. Accordingly, without hindering the execution of processing on the input data by the CPU 102 after the CPU 102 returns to the second operating state, the amount of power consumption of the terminal apparatus 100 can be suppressed.

The control circuit 300 of the embodiment is configured such that input data is transferred to the CPU 102, whereby the CPU 102 is switched from the first operating state to the second operating state. Thus, there is no need to perform processing for sending information for switching the CPU 102 from the first operating state to the second operating state to the CPU 102, separately from processing for transferring the input data. Accordingly, it is possible with a simpler configuration to control the switching of the state of the CPU 102 and suppress the amount of power consumption of the information processing apparatus.

As enterable areas in the embodiment, the area where the image 602 is displayed, the area where the image 604 is displayed, the area where the image 606 is displayed, the area where the image 608 is displayed, the area where the image 610 is displayed, and the area where the image 612 is displayed are set. However, the invention is not limited thereto. As an enterable area, only the image 602 showing the handwriting input field may be set, for example.

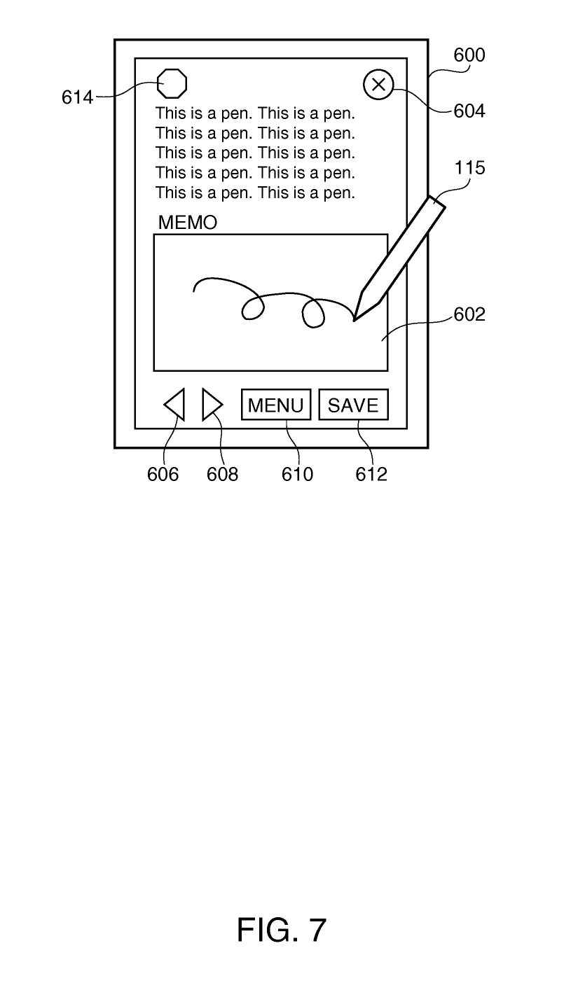

FIG. 7 shows a modified example of enterable areas. The screen 600 shown in FIG. 7 differs from the screen 600 shown in FIG. 6 in further including an image 614. In this example, the areas where the image 602 to the image 612 are displayed are not set as enterable areas. Instead, separately from the image 602 to the image 612, the image 614 of a return soft button to be pressed by the stylus pen 115 for switching the operating state of the CPU 102 from the sleep mode to the non-sleep mode is displayed on the screen 600, and the area where the image 614 is displayed is set as an enterable area.

In this modified example, since an enterable area is limited to the area where the image 614 of the return soft button is displayed, it is possible to effectively prevent the operating state of the CPU 102 from switching from the sleep mode to the non-sleep mode because of an erroneous operation of a user. As a result, the amount of power consumption of the terminal apparatus 100 can be more effectively suppressed. Further, if the return soft button is set so as not to be displayed when the CPU 102 is in the non-sleep mode, a user can easily recognize the operating state of the CPU 102. Therefore, unnecessary pressing can be prevented when there is no need to press the return soft button.

The controlling method of the invention is not limited to applications to the terminal apparatus 100. The controlling method of the invention may be applied to any information processing apparatus as long as the information processing apparatus includes at least a position detection type input device, a display device, and a CPU having the sleep mode. Moreover, the controlling method of the invention is not limited to those realized by the control circuit 300. The controlling method of the invention may be realized by any software or any hardware.

The entire disclosure of Japanese Patent Application No. 2010-093102, filed Apr. 14, 2010 is expressly incorporated by reference herein.

What is claimed is:

1. A controlling method performed by an information processing apparatus including an input device and a CPU, comprising:
acquiring input data including input position information indicating an input position at which an input is made in the input device;
determining whether or not the input position indicated by the input position information included in the input data corresponds to a predetermined enterable area; and
switching, when the CPU is in a first operating state and it is determined that the input position corresponds to the enterable area, the CPU from the first operating state to a second operating state where the power consumption is greater than that in the first operating state.

2. The controlling method according to claim 1, further comprising causing a storage section to store information indicating an area where an input can be made in the input device as information indicating the enterable area when the CPU transitions from the second operating state to the first operating state, wherein
it is determined with reference to the information indicating the enterable area stored in the storage section whether or not the input position specified by the input data corresponds to the enterable area.

3. The controlling method according to claim 1, further comprising transferring the input data to the CPU when the CPU is in the second operating state.

4. The controlling method according to claim 1, further comprising transferring the input data to the CPU when the CPU is in the first operating state and it is determined that the input position corresponds to the enterable area.

5. The controlling method according to claim 4, wherein
when the CPU receives the input data in the first operating state, the CPU can be switched from the first operating state to the second operating state, and
the input data is transferred to the CPU when it is determined that the input position corresponds to the enterable area, whereby the CPU is switched from the first operating state to the second operating state.

6. An information processing apparatus comprising:
an input device;
a CPU;
an acquiring section that acquires input data including input position information indicating an input position at which an input is made in the input device;
a determining section that determines whether or not the input position indicated by the input position information included in the input data corresponds to a predetermined enterable area; and
a state switching section that switches, when the CPU is in a first operating state and it is determined by the determining section that the input position corresponds to the enterable area, the CPU from the first operating state to a second operating state where the power consumption is greater than that in the first operating state.
